(19) United States
(12) Patent Application Publication
(10) Pub. No.: US 2010/0070730 A1
(43) Pub. Date: Mar. 18, 2010

(54) MINIMIZING MEMORY ACCESS CONFLICTS OF PROCESS COMMUNICATION CHANNELS

(76) Inventors: Sebastian Pop, Austin, TX (US); Jan Sjodin, Austin, TX (US); Harsha Jagasia, Austin, TX (US)

Correspondence Address: MEYERTONS, HOOD, KIVLIN, KOWERT & GOETZEL (AMD), P.O. BOX 398, AUSTIN, TX, 78767-0398, US

(21) Appl. No.: 12/212,370

(22) Filed: Sep. 17, 2008

(51) Int. Cl. G06F 12/00

(52) U.S. Cl. 711/167; 711/E12.001

(57) ABSTRACT

A system and method for minimizing cache conflicts and synchronization support for generated parallel tasks within a compiler framework. A compiler comprises library functions to generate a queue for parallel applications and divides it into windows. A window may be sized to fit within a first-level cache of a processor. Application code with producer and consumer patterns within a loop construct has these patterns split into producer and consumer tasks. Within a producer task loop, a function call is placed for a push operation that modifies a memory location within a producer sliding window without a check for concurrent accesses. A consumer task loop has a similar function call. At the time a producer or consumer task is ready to move, or slide, to an adjacent window, its corresponding function call determines if the adjacent window is available.

### BACKGROUND OF THE INVENTION

1. Field of the Invention

This invention relates to computer systems, and more particularly, to minimizing cache conflicts and synchronization support for generated parallel tasks with a compiler framework.

2. Description of the Relevant Art

Both hardware and software determine the performance of computer systems. Hardware design is becoming difficult to generate more performance due to cross capacitance effects on wires, parasitic inductance effects on wires, and electrostatic field effects within transistors, which increase circuit noise effects on-chip and propagation delays. Additionally, continuing decreases in geometric dimensions of devices and metal routes may increase these effects. Also, the number of switching nodes per clock period increases as more devices are placed on-chip, and, thus, the power consumption increases. These noise and power effects limit the operational frequency, and, therefore, the performance of the hardware.

While the reduction in geometric dimensions on-chip discussed above may lead to larger caches and multiple cores placed on each processor, software and software programmers cannot continue to depend on ever-faster hardware to hide inefficient code. In some cases hardware traits may increase performance if the execution of parallel applications, such as multi-threaded applications, executed on multi-core processors and chips ensure that concurrent accesses by multiple threads to shared memory, such as the multiple first-level caches, are synchronized. This synchronization ensures correctness of operations, but also may limit peak performance. For example, locking mechanisms, such as semaphores or otherwise, may ensure correctness of operations, but may also limit peak performance.

Some lock-free mechanisms may be used that allow a thread to complete read and write operations to shared memory without regard for operations of other threads. Each operation may be recorded in a log. Before a commit of the thread occurs, validation is performed. If it is found that other threads concurrently modified the same accessed memory locations, then re-execution is required. This re-execution may limit peak performance.

Another option for increasing performance of parallel applications from a software point-of-view is the management of the use of scratchpad memories, such as concurrent first-in-first-out (FIFO) queues implemented in a cache hierarchy. Many lock-free algorithms are based on compare and swap (CAS) algorithms. The CAS algorithm takes as arguments the address of a shared memory location, an expected value, and a new value. If the shared location currently holds the expected value, it is assigned the new value atomically (an atomic operation may generally represent one or more operations that have an appearance of a single operation to the rest of the system). A Boolean return value may be used to indicate whether the replacement occurred.

However, CAS algorithms deal with “ABA” problems, wherein a process reads a value A from a shared location, computes a new value, and then the process attempts a CAS operation. Between the read operation and the CAS operation other processes may change the value in the shared location from A to B, do other work, and then change the value in the shared location back to A again. Now the first thread is still executing under the assumption that the value has not changed even though another thread did work that violates that assumption. The CAS operation will succeed when it should not. Another example is within a lock-free queue, a data element may be removed from a list within the queue, deleted, and then a new data element is allocated and added to the list. It is common for the allocated new data element to be at the same location as the deleted data element due to optimizations in the memory manager. A pointer to the new data element may be equal to a pointer to the old data element.

One solution to the above problem is to associate tag bits, or a modification counter, to a data element. The counter is incremented with each successful CAS operation. Due to wrap around, the problem is reduced, but not eliminated. Some architectures provide a double-word CAS operation, which allows for a larger tag. However, on-chip real estate is increased as well as matching circuitry delays. Another solution performs a CAS operation in a fetch and store-modify-CAS sequence, rather than the usual read-modify-CAS sequence. However, this solution makes the algorithm blocking rather than non-blocking.

A wait-free algorithm is both non-blocking and starvation free, wherein the algorithm guarantees that every active process will make progress within a bounded number of time steps. An example of a wait-free algorithm includes L. Lamport, Specifying Concurrent Program Modules, ACM Transactions on Programming Languages and Systems, Vol. 5, No. 2, April 1983, pp. 190-222. However, Lamport presents a wait-free algorithm that restricts concurrency to a single enqueued element and a single dequeued element and the frequency of occurrence of required synchronization is not reduced.

In view of the above, efficient methods and mechanisms for improving the generation of parallel tasks from sequential code and execution of the parallel tasks while minimizing cache conflicts are desired.

### SUMMARY OF THE INVENTION

Systems and methods for minimizing cache conflicts and synchronization support for generated parallel tasks within a compiler framework are contemplated. Application code has producer and consumer patterns in a loop construct divided into two corresponding loops or tasks. An array's elements, or a subset of the elements, are updated or modified in the producer task. The same array elements or a subset of the array's elements are read out in the consumer task in order to compute a value for another variable within the loop construct. In one embodiment, a method comprises dividing a stream into windows, wherein a stream is a circular first-in, first-out (FIFO) shared storage queue. In one window, a producer task is able to modify memory locations within a producer sliding window without checking for concurrent accesses to the corresponding elements.

Upon filling the producer sliding window, the producer task may move to an adjacent window to continue computational work. However, at this moment of moving, or sliding, to an adjacent window, the producer task verifies that a consumer task is not reading values from this adjacent window. The method performs similar operations for a consumer task wherein a consumer task is able to read memory locations within a consumer sliding window without checking for concurrent accesses to the corresponding elements. Since synchronization is limited to the times a producer or a consumer task completes its corresponding operations in a window and the task is ready to move to an adjacent window, the penalty for synchronization may be reduced.

In various embodiments, a compiler comprises library functions that may be either placed in an intermediate representation of an application code by back-end compilation or placed in source code by a software programmer. These library functions are configured to generate a stream and divide it into windows. A window is sized both to fit within a first-level cache of a processor and to reduce the chances of eviction from this first-level cache. Within a producer task loop, a function call may be placed for a push operation that modifies a memory location within a producer sliding window without checking for concurrent accesses to the corresponding elements. Likewise, within a consumer task loop, a function call may be placed for a pop operation that reads a memory location within a consumer sliding window without checking for concurrent accesses to the corresponding elements. At the time a window is filled by a producer task, or a window is emptied by a consumer task, the corresponding function call performs a determination of whether or not an adjacent window is available for continued work. If an adjacent window is available, the corresponding task moves, or slides, from its current window to the adjacent window. Otherwise, the corresponding task waits until the adjacent window is available.

### BRIEF DESCRIPTION OF THE DRAWINGS

FIG. 1 is a generalized block diagram illustrating one embodiment of an exemplary processing node.

FIG. 2 is a flow diagram of one embodiment of a static compiler method.

FIG. 3A is a generalized block diagram illustrating one embodiment of source code pattern with regular data dependences within an array.

FIG. 3B is a generalized block diagram illustrating one embodiment of source code pattern with shifted data dependences within an array.

FIG. 3C is a generalized block diagram illustrating one embodiment of source code pattern with irregular data dependences within an array.

FIG. 4 is a generalized block diagram illustrating one embodiment of a memory hierarchy that supports producer and consumer sliding windows.

FIG. 5 is a flow diagram illustrating one embodiment of a method for automatic parallelization.

FIG. 6 is a flow diagram illustrating one embodiment of a method for executing a producer task.

FIG. 7 is a flow diagram illustrating one embodiment of a method for executing a consumer task.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention may be practiced without these specific details. In some instances, well-known circuits, structures, and techniques have not been shown in detail to avoid obscuring the present invention.

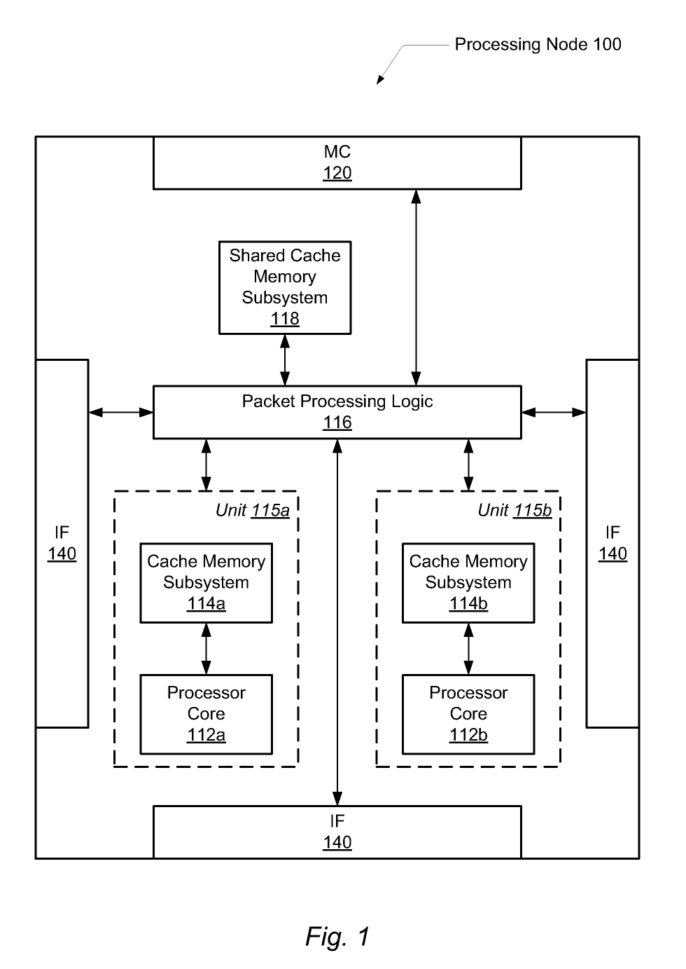

FIG. 1 is a block diagram of one embodiment of an exemplary processing node 100. Processing node 100 may include memory controller 120, interface logic 140, one or more processing units 115a-115b. As used herein, elements referred to by a reference numeral followed by a letter may be collectively referred to by the numeral alone. For example, processing units 115a-115b may be collectively referred to as processing units 115. Processing units 115 may include a processor core 112 and a corresponding cache memory subsystems 114. Processing node 100 may further include packet processing logic 116, and a shared cache memory subsystem 118. In one embodiment, the illustrated functionality of processing node 100 is incorporated upon a single integrated circuit.

Generally, packet processing logic 116 is configured to respond to control packets received on the links to which processing node 100 is coupled, to generate control packets in response to processor cores 112 and/or cache memory subsystems 114, to generate probe commands and response packets in response to transactions selected by memory controller 120 for service, and to route packets for which node 100 is an intermediate node to other nodes through interface logic 140. Interface logic 140 may include logic to receive packets and synchronize the packets to an internal clock used by packet processing logic 116.

Cache subsystems 114 and 118 may comprise high speed cache memories configured to store blocks of data. Cache memory subsystems 114 may be integrated within respective processor cores 112. Alternatively, cache memory subsystems 114 may be coupled to processor cores 114 in a backside cache configuration or an inline configuration, as desired. Still further, cache memory subsystems 114 may be implemented as a hierarchy of caches. Caches which are nearer processor cores 112 (within the hierarchy) may be integrated into processor cores 112, if desired. In one embodiment, cache memory subsystems 114 each represent L2 cache structures, and shared cache subsystem 118 represents an L3 cache structure.

Both the cache memory subsystem 114 and the shared cache memory subsystem 118 may include a cache memory coupled to a corresponding cache controller. For the shared cache memory subsystem 118, the cache controller may include programmable logic in order to programmably enable a storage of directory entries within locations of subsystem 118.

Processor cores 112 include circuitry for executing instructions according to a predefined instruction set. For example, the x86 instruction set architecture may be selected. Alternatively, the Alpha, PowerPC, or any other instruction set architecture may be selected. Generally, processor core 112 accesses the cache memory subsystems 114, respectively, for data and instructions. If the requested block is not found in cache memory subsystem 114 or in shared cache memory subsystem 118, then a read request may be generated and transmitted to the memory controller within the node to which the missing block is mapped.

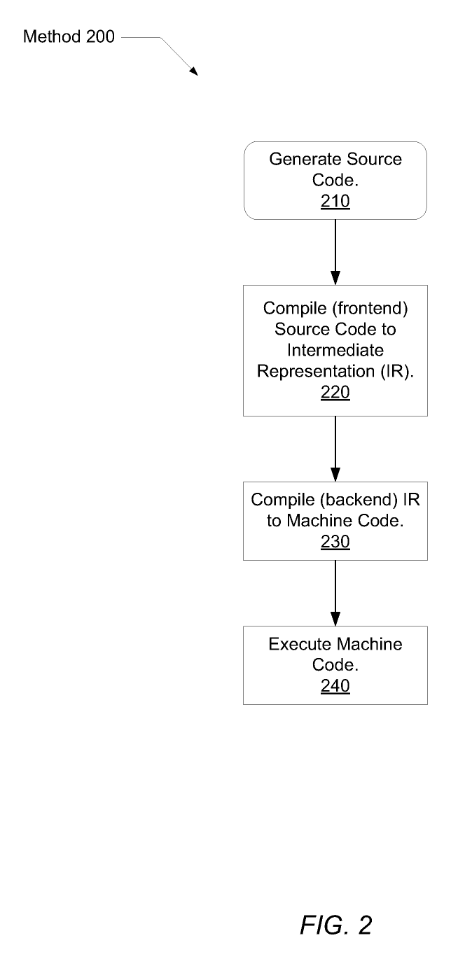

Referring to FIG. 2, one embodiment of a static compiler method 200 is shown. Software applications may be written by a designer in a high-level language such as C, C++, Fortran, or other in block 210. This source code may be stored on a computer readable medium. A command instruction, which may be entered at a prompt by a user, with any necessary options may be executed in order to compile the source code. One example of a compiler is the GNU Compiler Collection (GCC), which is a set of compilers produced for various programming languages. However, other examples of compilers are possible and contemplated.

In block 220, in one embodiment, the front-end compilation translates the source code to an intermediate representation (IR). Syntactic and semantic processing as well as some optimizations may be performed at this step. The back-end compilation in block 230 translates the IR to machine code. The back-end may perform more transformations and optimizations for a particular computer architecture and processor design. For example, a processor is designed to execute instructions of a particular instruction set architecture (ISA), but the processor may have one or more processor cores. The manner in which a software application is executed (block 240) in order to reach peak performance may differ greatly between a single-, a dual-, or a quad-core processor. Other designs may have eight cores. Regardless, the manner in which to compile the software application in order to achieve peak performance may need to vary between a single-core and a multi-core processor.

Lock contention may be used to prevent potential overlapped accesses to shared memory, such as caches in memory subsystem 114 and 118 in FIG. 1. However, it also reduces performance when cores are in a wait state until the lock is removed. Transactional memory may be used to prevent halted execution. However, if a memory conflict is later found during a validation stage, a particular thread may roll back its operations to a last validated checkpoint or the start of the thread and begin re-execution. In another embodiment, the thread may be aborted and rescheduled for execution at a later time.

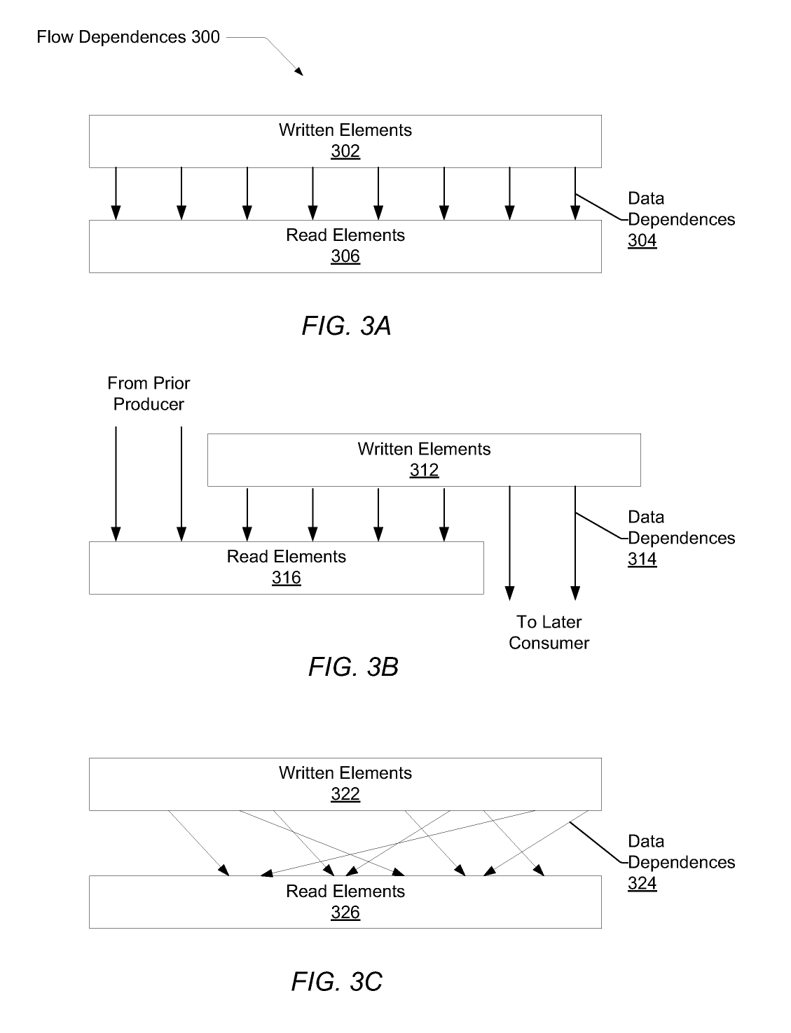

The above examples of synchronization are used to ensure a producer and a consumer do not concurrently access the same memory location. A producer may correspond to a processor core, such as processor core 112a in FIG. 1, supplying data, such as in an array, while executing a task or a thread. A consumer may correspond to a processor core, such as processor core 112b in FIG. 1, retrieving data, such as in an array, while executing a parallel task or a parallel thread. For example, referring to FIG. 3A, one embodiment of a source code pattern with regular data dependences within an array is shown. Automatic parallelization techniques are based on data dependence analysis information.

Here, an array has its elements updated, such as written elements 302, and subsequently these elements are read out, which are represented by read elements 306. FIG. 3A represents a regular data flow relation in which all the elements written by the producer are read by a same consumer. This one-to-one correlation is depicted by data dependences 304. For example, suppose a designer has written source code that contains the below code segment now in the IR,

| | |
|---|---|
| for (i = 0; i < n; i++) { | /* line 1 */ |
| a[i] = variable1 op variable2; | |
| variable3 = a[i] op variable4; | |
| } | /* line 4 */ |

The compiler may split this loop into two parallel loops,

| | |
|---|---|
| /* Producer Task */ | |
| for (i = 0; i < n; i++) { | /* line 5 */ |
| a[i] = variable1 op variable2; | |
| } | /* line 7 */ |
| /* Consumer Task */ | |
| for (i = 0; i < n; i++) { | /* line 9 */ |
| variable3 = a[i] op variable4; | |
| } | |

The automatic parallelization techniques of a compiler, such as in a runtime parallelization library, are based on data dependence analysis information. This static analysis determines the relations between memory accesses and allows the analysis of dependences between computations via memory accesses. This in turn allows task partitioning, and data and computation privatization. Data dependences represent a relation between two tasks. In the case of flow dependences, the dependence relation is between a task that writes data and another task that is reading it.

In FIG. 3B only a part of the elements of an array are written, making a part of the read elements dependent on a previous producer. Likewise, it may occur that only a part of the elements of an array are read, making part of the written elements dependent on a later consumer. Here, an array has its elements partially updated, such as written elements 312, and subsequently these elements are read out, which are represented by partial read elements 316. FIG. 3B represents a shifted data flow relation in which partial of the elements written by the producer are read by a same consumer. This type of shifted data dependence is depicted by data dependences 314. For example, suppose a designer has written source code that contains the below code segment now in the IR,

| | |
|---|---|
| for (i = 0; i < n; i++) { | /* line 12 */ |
| a[i+2] = variable1 op variable2; | |
| variable3 = a[i] op variable4; | |
| } | /* line 15 */ |

The compiler may split this loop into two parallel loops,

| | |
|---|---|
| /* Producer Task */ | |
| for (i = 1; i <= n; i++) { | /* line 17 */ |
| a[i+2] = variable1 op variable2; | |
| } | /* line 19 */ |
| /* Consumer Task */ | |
| for (i = 1; i <= n; i++) { | /* line 21 */ |
| variable3 = a[i] op variable4;; | |
| } | |

FIG. 3C represents a more difficult dependence relation that may not be determined at compile time. Here, an array may have its elements fully or partially updated, such as written elements 322, and subsequently these elements are read out, which are represented by partial read elements 326. However, the reading out of the elements may not be in array-order in the sequential code. FIG. 3C represents an irregular data flow relation not known at compile time. This type of irregular data dependence is depicted by data dependences 324. The read elements 326 may be accessed by an indirection. For example, suppose a designer has written source code that contains the below code segment now in the IR,

| | |
|---|---|
| for (i = 0; i < n; i++) { | /* line 24 */ |
| a[i] = variable1 op variable2; | |
| variable3 = a[b(i)] op variable4; | |
| } | /* line 27 */ |

In the above example, the read elements are accessed by an indirection and, accordingly, the consumer task may then be considered dependent on the completion of the producer task.

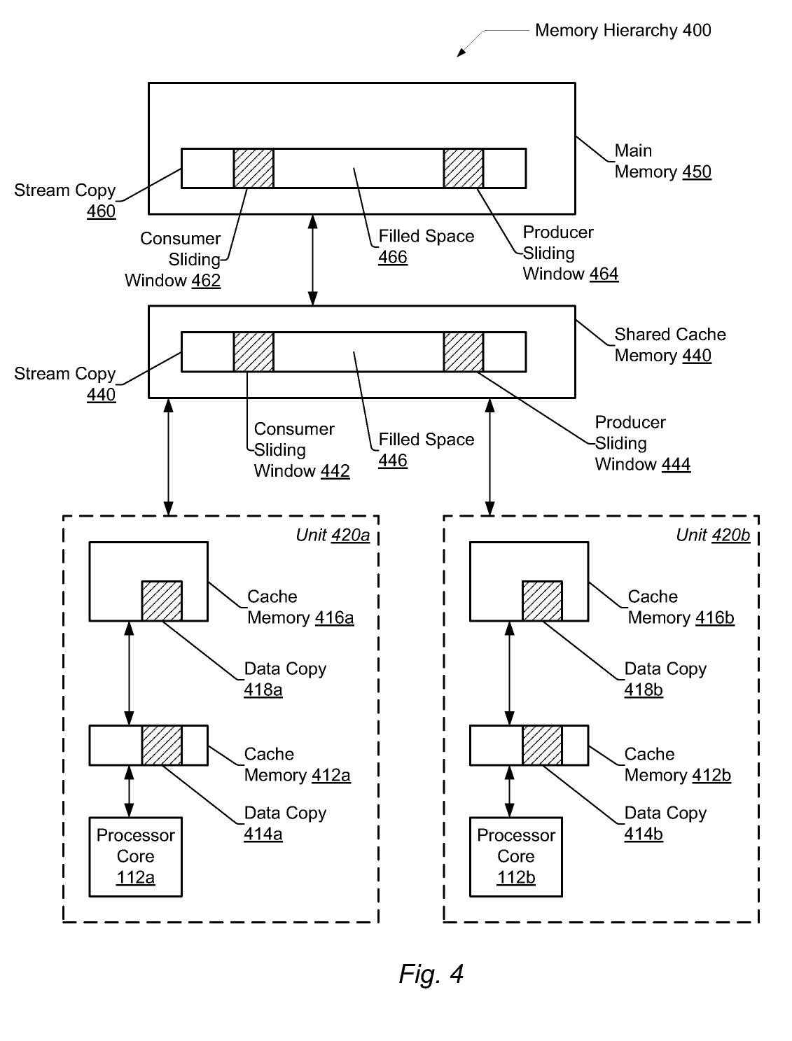

Turning now to FIG. 4, one embodiment of a memory hierarchy 400 that supports producer and consumer sliding windows is shown. Processing units 420 may be similar to processing units 115 of FIG. 1. The same circuitry for processor cores 112 of FIG. 1 may be used here as well. In one embodiment, the cache subsystem is shown as two levels, 412 and 416, but other embodiments may be used as well. Cache memory 412 may be implemented as a L1 cache structure and may be integrated into processor core 112, if desired. Cache memory 416 may be implemented as a L2 cache structure. Other embodiments are possible and contemplated. Interfaces are not shown here as they are in FIG. 1 for simpler illustrative purposes. A shared cache memory 440 may be implemented as a L3 cache structure. Here, the shared cache memory 440 is shown as one level, but other levels and implementations are possible.

Again, an interface, such as a memory controller, to main memory 450 is not shown for simpler illustrative purposes. Main memory 450 may be implemented as dynamic random-access memory (DRAM), dual in-line memory modules (dimms), a hard disk, or otherwise.

The transfer of data between tasks as shown in FIG. 3A-3C may occur via a communication channel called a stream. A stream may be a circular buffer managed as a FIFO concurrent lock free queue. Concurrent FIFO queues are widely used in parallel applications and operating systems. A stream may be implemented in the memory hierarchy 400 such as in stream copies 440 and 460. The most updated contents of a stream may be in stream copies located closest to a processor core, such as stream copy 440.

As shown above in FIG. 3A-3C, a loop in source code with a regular or shifted flow dependence may be split into two parallel tasks such as a producer task and a consumer task. Each task may be provided a sliding window, or local buffer, within the stream. For example, in one embodiment, processor core 112b may be assigned a producer task as depicted by lines of code 5-7 above and processor core 112a may be assigned a consumer task as depicted by lines of code 9-11 above. Stream 460 may be created for the parallel tasks in code lines 5-11. Stream 440 may be a more up-to-date copy of stream 460.

Producer sliding window 444, and correspondingly 464, may be empty and designated for storing data produced by core 112b. In fact, a snapshot in the middle of code execution may show core 112b has produced data for the loop of lines 5-7, which is presently stored in filled space 446. The pointers within stream 440 may have been updated and core 112b is now allowed to begin filling producer sliding window 444 with new data. More up-to-date copies of producer sliding window 444 may be found in the cache hierarchy, such as data copies 418b and 414b. In fact, the size of the producer sliding window and its copies may be chosen in order that the window remains located in closest cache to processor 112b with a low chance of being evicted. Therefore, cache conflicts may be reduced.

While processor core 112b is executing a producer task, producing data for stream copies 440 and 460, and filling data copy 414b to be subsequently sent to producer sliding windows 444 and 464, processor core 112a may be concurrently executing a consumer task, reading data from stream copy 440, and reading from data copy 414a which was previously read from consumer sliding window 442. Consumer sliding window 442, and correspondingly 462, may be full and designated for reading data by core 112a. In fact, a snapshot in the middle of code execution may show core 112a is reading data for the loop of lines 9-11, which is presently stored in filled space 446. The pointers within stream 440 may have been updated and core 112a is now allowed to begin reading consumer sliding window 442 which has new data. More up-to-date copies of consumer sliding window 442 may be found in the cache hierarchy, such as data copies 418a and 414a. The size of the consumer sliding window may be the same size as the producer sliding window for ease of implementation sake. Alternatively, when core 112a has permission to read from a window due to no overlap of the producer and consumer sliding windows, rather than read data from stream copy 440, core 112a may send a communicative probe to locate required data. If a copy of the required updated data is in cache 416b or 412b of processing unit 420b, then a copy of the required data may be sent from processing unit 420b to cache 412a.

As can be seen in FIG. 4, as long as the producer sliding window 444 does not overlap the consumer sliding window 442, both cores 112a-112b may execute in parallel without conflicting memory accesses. In fact, the only penalty for synchronization occurs when a producer sliding window 444 or a consumer sliding window 442 needs to slide within stream 440. A check must be performed to ensure there is no overlap between the windows. Further details are provided later. Of course, consumer sliding window 442 can not begin reading and sliding until producer sliding window 444 has filled at least one window within stream 440 and subsequently moved to another window within stream 440. This is a small overhead price to be paid during initial execution of the parallel tasks. By allowing cores 112a-112b to concurrently execute on data within copies of sliding windows 442 and 444 and only needing to perform synchronization during times when a window needs to slide, peak performance of a system may be more easily achieved.

The embodiment shown in FIG. 4 is for illustrative purposes only. In other embodiments, more than two processing units 420 may be included in a system and more than one stream 440 may be concurrently implemented in shared cache memory 440 and main memory 450. In the above example, the producer sliding window 444 and consumer sliding window 442 are shown moving from left to right, but in other embodiments, they may move from right to left. Also, the producer sliding window 444 may wrap around stream 440 during execution and, in a snapshot, be located to the left of consumer sliding window 442. Also, for a multi-core processor implementation, a stream 440 may correspond to a single processor and to a single processing unit 420, wherein a producer sliding window 444 corresponds to a first core within a multi-core processor and consumer sliding window 442 corresponds to a second core within the same multi-core processor. Other combinations and embodiments are possible and contemplated.

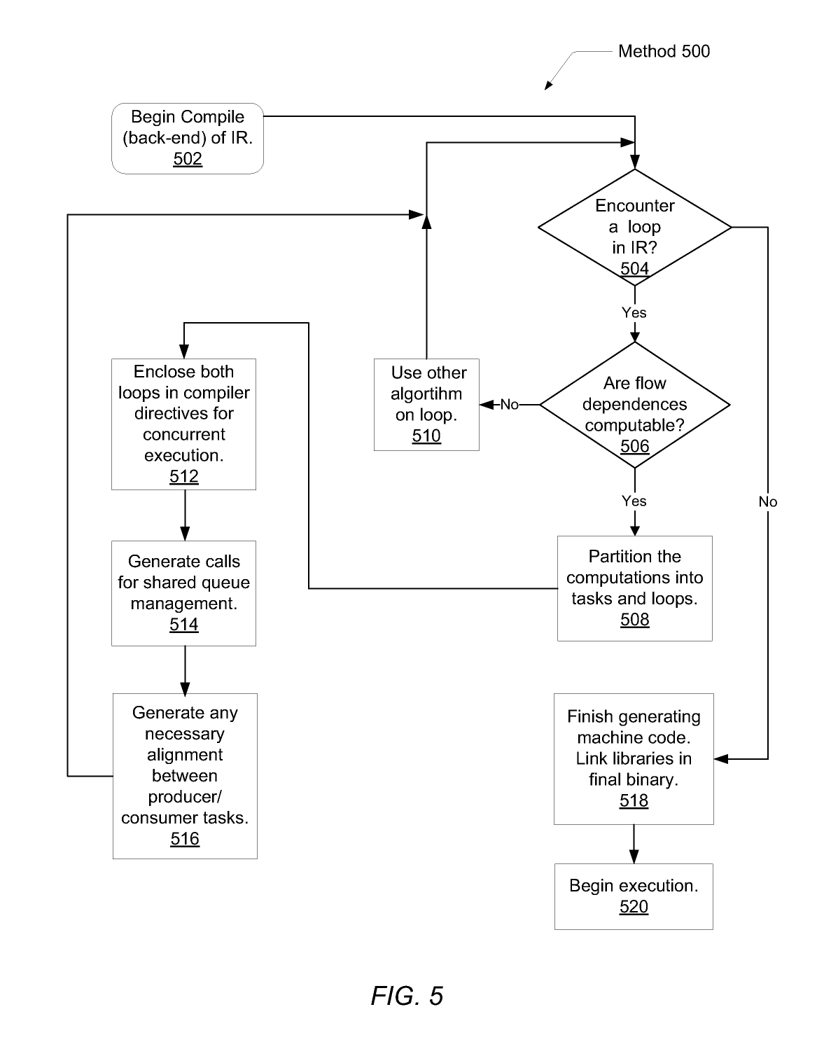

Turning now to FIG. 5, one embodiment of a method 500 for automatic parallelization is shown. Method 500 may be modified by those skilled in the art in order to derive alternative embodiments. Also, the steps in this embodiment are shown in sequential order. However, some steps may occur in a different order than shown, some steps may be performed concurrently, some steps may be combined with other steps, and some steps may be absent in another embodiment. In the embodiment shown, source code has been translated and optimized by front-end compilation and the respective IR has been conveyed to a back-end compiler in block 502.

If parallel constructs, such as a “for” loop or a “while” loop, have been found in the IR (conditional block 504), the loop may be inspected for a single-entry and single-exit point (conditional block 506). Here, a simple exit condition may be an index variable being decremented in any fashion. Any other method may also be used. The work within the loop include functions and/or computations designed by a software programmer and an index variable is supplied as an input parameter. The computations must not alter the index variable value.

If a loop is found with multiple entries (conditional block 506), another method or algorithm may be needed to parallelize the loop, or the loop is executed in a serial manner in block 510. The same may be true for a loop with multiple exits. If a loop is found in the IR with a single-entry and a single-exit, code replacement and code generation by the back-end compiler may be performed using function calls defined in a parallelization library (PL). For the use of a stream, however, the flow dependences of an array within the loop may need to be regular or shift as shown in FIG. 3A-3B. If this is the case, then control flow of method 500 moves to block 508. Otherwise, control flow moves to block 510.

In block 508, the computations within the loop are partitioned into producer and consumer tasks. The original loop may be split into two loops to be concurrently executed. One loop may be for producer tasks, such as shown in code lines 5-7 above, and a second loop may be for consumer tasks, such as shown in code lines 9-11 above. In block 512, a compiler directive may be included in the compiled code to enclose the two loops and provide a directive for parallel execution. One example of such a directive may be an Open Multi-Processing (OpenMP) pragma. OpenMP is an application programming interface (API) that supports shared memory multiprocessing programming in C, C++, and Fortran languages on many architectures, including Unix and Microsoft Windows platforms. OpenMP consists of compiler directives, library routines, and environment variables that influence run-time behavior. To parallelize the tasks that have been previously partitioned, calls are generated to the extended OpenMP library. The tasks are enclosed in OpenMP sections that execute concurrently.

Then, in block 514, calls are introduced to the appropriate functions to provide for communication and synchronization. In one embodiment, in the producer task, a call may be generated, such as “gomp_stream_push”, after the write operation that was at the origin of the flow dependence. As used herein, “push”, “write”, and “modify” operations have the same meaning, which is to modify a value, such as one stored in a memory location, unless otherwise described. Similarly, “pop” and “read” operations have the same meaning. Another example of a loop with shifted data flow dependence, wherein an example is shown in FIG. 3B, that may be partitioned into producer and consumer tasks follows,

| | |
|---|---|
| for (i = 1; i <= n; i++) { | /* line 28 */ |
| a[i] = variable1 op variable2; | |
| variable3 = a[i−1] op variable4; | |
| } | /* line 31 */ |

The compiler may split this loop into two parallel loops,

| | |
|---|---|
| /* Producer Task */ | |
| for (i = 1; i <= n; i++) { | /* line 33 */ |
| a[i] = variable1 op variable2; | |
| } | /* line 35 */ |
| /* Consumer Task */ | |
| for (i = 1; i <= n; i++) { | /* line 37 */ |
| variable3 = a[i−1] op variable4; | |
| } | |

The automatic code generated by the compiler for these two tasks may appear as follows,

| | |
|---|---|
| gomp_stream s = gomp_stream_create (4, 1024, 64); | /* line 40 */ |
| #pragma omp parallel sections num threads (2) | |
| { | |
| #pragma omp section | |
| /* Producer task */ | |
| { | /* line 45 */ |
| gomp_stream_align_push (s, a, 1); | |
| for (i=1; i<=n; i++) { | |
| elt e = variable1 op variable2; | |
| a[i] = e; | |
| gomp_stream_push (s, e); | /* line 50 */ |
| } | |
| gomp_stream_set eos (s); | |
| } | |
| #pragma omp section | |
| /* Consumer task. */ | /* line 55 */ |
| { | |
| for (i=1; i<=n; i++) { | |
| elt t = gomp_stream_head (s); | |
| gomp_stream_pop (s); | |
| variable3 = t op variable4; | /* line 60 */ |
| } | |
| gomp_stream_align_pop (s, 1); | |
| gomp_stream_destroy (s); | |
| } | |
| } | /* line 65 */ |

The write operation at line 34 of the producer task is replaced with lines 49-50 of the automatically generated stream code. Note that without precise interprocedural analysis to decide if there are further uses of that memory location, the write operation cannot be removed. Subsequent reads to that memory location may remain. For example, line 49 above writes the value e into a memory location in main memory, such as memory 450 of FIG. 4. This memory location is located outside of a scratchpad memory, such as stream 460. The value e may be initially written to a location in a cache, such as cache 412b, but ultimately, that value will be written into memory 450. Line 50 above in the stream code ultimately modifies a location in the stream copy 460. Once the parallel producer and consumer loops have finished execution, stream 460 may be freed for use in other computations. If line 49 of the above stream code is removed, the computed data values for the array would be lost. If a later computation needs those values, then correctness is lost. If an interprocedural analysis is in place that ensures no subsequent read operations need the array values beyond the current consumer task, then line 49 above may be removed.

Continuing with block 514 of method 500, within the consumer task, a call may be generated, such as “gomp_stream_head”, in place of a read operation. In one embodiment, the read operation at line 38 of the consumer task is replaced with lines 58-59 of the automatically generated stream code. The call “gomp_stream_head” at line 58 reads the element data from the consumer sliding window, and therefore, from the stream. Again, this read operation of the element data may be from data copy 414a within cache 412a. The call “gomp_stream_pop” updates a read index pointer within the stream in order to remove the element from the consumer sliding window, and therefore, from the stream. In this embodiment, the decision to split this operation is to allow, in some cases, the removal of an unnecessary copy of the element from the stream to a temporary location. This may be significant if the elements within a consumer sliding window occupy a lot of space.

In block 516, code is generated to align the producer and consumer sliding windows. In the example proposed above, the producer task will push a computed value for a[1] into the stream. Later, the consumer expects to initially pop a value for a[0]. Therefore, an alignment is required. In one embodiment, two alignment functions may be provided for this purpose such as “gomp_stream_align_push” at line 46 above and “gomp_stream_align_pop” at line 62 above. The number of elements to align is known from the data dependence analysis which provides information in the form of a distance vector associated with this flow dependence.

Control flow of method 500 then moves from block 516 to conditional block 504. If no more loops are encountered in the code (conditional block 504), then control flow moves to block 518. Here, the corresponding code style is translated to binary machine code and function calls defined in libraries, such as the PL, are included in the binary. Execution of the machine code follows in block 520. It should be noted that in the example above, the stream code in lines 40-65 above may be generated by a compiler, such as, in one embodiment the GNU Compiler Collection (GCC), is similar to code that may be written by a software programmer using OpenMP calls to the GOMP (GNU OpenMP library implementation) streams. Therefore, although the above example illustrates an automatic code generation, such as for large legacy code, the principles may be applied for new code written by a software programmer.

Methods 600 and 700, which are described shortly, are methods for executing a producer task and a consumer task, respectively. These methods may be concurrently executed once the overhead of filling a first producer sliding window has been performed. Before concurrent execution may begin for these tasks, a stream needs to be defined and the producer and consumer sliding windows need to be defined within the stream. For example, in one embodiment, line 40 above creates a stream for the upcoming parallel computations. In this particular embodiment, the created stream has 1024 sliding windows. Each sliding window has a size of 64 bytes (64 B) and each element within a window has a size of 4 B. Therefore, there are 16 elements per sliding window and the entire stream is 64 KB in size. A sample structure for the stream is provided in the following,

| | |
|---|---|
| typedef struct gomp_stream { | /* line 66 */ |
| /* First element of the stream. */ | |
| unsigned read_index; | |
| /* First empty element of the stream. */ | |
| unsigned write_index; | /* line 70 */ |
| /* Size of sub-buffers for unsynchronized reads and writes. */ | |
| unsigned local_buffer_size; | |
| /* Index of the sliding reading window. */ | |
| unsigned read_buffer_index; | |
| /* Index of the sliding writing window. */ | /* line 75 */ |
| unsigned write_buffer_index; | |
| /* End of stream: true when producer has finished inserting elements. */ | |
| bool eos_p; | |
| /* Size in bytes of an element in the stream. */ | |
| size_t size; | /* line 80 */ |
| /* Number of bytes in the circular buffer. */ | |
| unsigned capacity; | |
| /* Circular buffer. */ | |
| char *buffer; | |
| } *gomp_stream; | /* line 85 */ |

In the embodiment shown, a producer sliding window is defined by the pointers “write_buffer_index” and “write_index” in lines 76 and 70 above, respectively. In one embodiment, the first pointer may point to an address value of the head of the producer sliding window and the second pointer may be initialized to zero. With each element that is pushed into the producer sliding window, the “write_index” may be incremented until it reaches a value equal to the number of elements in a sliding window minus one. Alternatively, the “write_index” may be initialized to a value equal to the address of the tail of the producer sliding window. With each element that is pushed into the producer sliding window, the “write_index” may be incremented until it reaches a value equal to the “write_buffer_index”. Other alternatives for updating the pointers such as decrementing or other are possible and contemplated.

Similarly, a consumer sliding window is defined by the pointers “read_buffer_index” and “read_index” in lines 74 and 68 above, respectively. In one embodiment, the first pointer may point to an address value of the head of the consumer sliding window and the second pointer may be initialized to zero. With each element that is popped from the consumer sliding window, the “read_index” may be incremented until it reaches a value equal to the number of elements in a sliding window minus one. Alternatively, the “read_index” may be initialized to a value equal to the address of the tail of the consumer sliding window. With each element that is popped from the consumer sliding window, the “read_index” may be incremented until it reaches a value equal to the “read_buffer_index”. Other alternatives for updating the pointers such as decrementing or other are possible and contemplated.

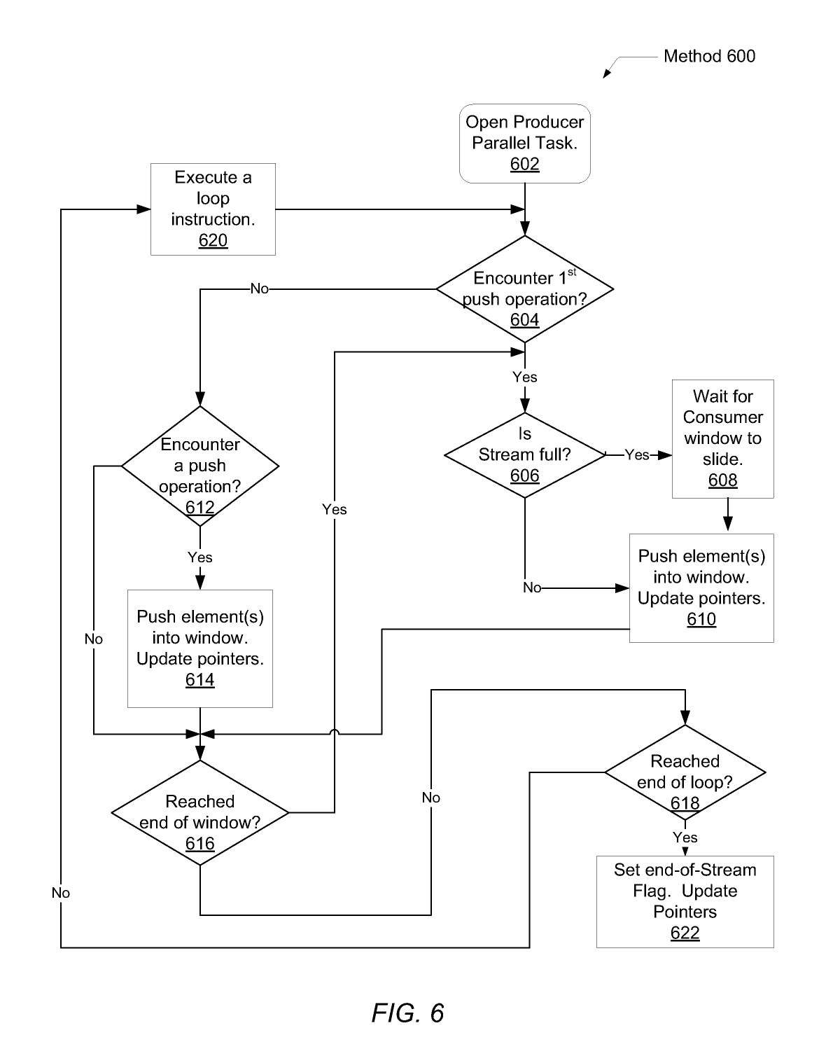

Referring to FIG. 6, one embodiment of a method 600 for executing a producer task is shown. Method 600 may be modified by those skilled in the art in order to derive alternative embodiments. The steps in this embodiment are shown in sequential order. However, some steps may occur in a different order than shown, some steps may be performed concurrently, some steps may be combined with other steps, and some steps may be absent in another embodiment. In the embodiment shown, a stream is created and index pointers are initialized, such as in line 40 in the above example, and a producer task is opened in block 602, such as in lines 43-45 above.

A first push operation may be encountered in the code (conditional block 604). This first push operation may be due to an alignment function call, or, in the case of no alignment is necessary, due to the first push operation encountered within a loop construct if no alignment with a consumer task is necessary. In the first case of a necessary alignment, the flow dependence analysis may determine a shifted data dependence, as one example is illustrated in FIG. 3B. Then a task alignment function call needs to be placed in the stream code. If such a function call, such as line 46 above, is encountered (conditional block 604), then a check is performed to determine if the stream is already full (conditional block 606). In one embodiment, a stream may be determined to be full if a producer sliding window is adjacent and “behind” a consumer sliding window. For example, if a producer sliding window moves along the stream, wraps around the stream, which is a circular buffer, and the producer sliding window now occupies a window adjacent to the consumer sliding window, then the producer sliding window is not able to move to an available window until the consumer sliding window moves. Therefore, the stream is considered full.

In one embodiment, a Boolean value, such as a full flag, may be stored to indicate whether or not the corresponding stream is full. In one embodiment, this full flag value may be set at the completion of a producer task within a sliding window and subsequent both the update of the “write_buffer_index” and a comparison of the values of the updated “write_buffer_index” and the “read_buffer_index”. If the index values are equal, then the stream is full. This full flag may be reset at the completion of a consumer task within the sliding window and subsequent the update of the “read_buffer_index”. When the full flag is reset, the producer task may begin work within the current sliding window. Note that when the stream is initially created, the “write_buffer_index” and “read_buffer_index” may be initialized to a same value that points to the first sliding window within the stream. However, the full flag is initialized to a value to indicate the stream is not full.

In another embodiment, the producer sliding window may be filled one element at a time in a sequential manner and the “write_index” value in line 70 above may be a pointer to elements within the producer sliding window. A check by a dispatcher within a processor may use this “write_index” value to know if available space exists within the producer sliding window during a particular clock cycle. For an embodiment that allows multiple elements to be pushed, sequentially by location, in a clock cycle, the control circuitry may be more complex than merely determining if the last element within in producer sliding window is about to be pushed. Now the end of a producer sliding window condition is determined and a check may now be performed to verify if the adjacent window is available for continued work of the producer task.

In one embodiment, this determination may include updating (e.g. incrementing or decrementing depending on the direction of the stream) the pointer value “write_buffer_index” to point to the adjacent window. An equal comparison of this value with the “read_buffer_index” pointer value may indicate the stream is full.

In another embodiment, a counter may be initialized to the number of sliding windows within a stream upon the creation of the corresponding stream. Each time a producer task begins work within a sliding window, the counter may be decremented. Similarly, each time a consumer task completes work within a sliding window, the counter may be incremented. When the counter holds the value of the total number of sliding windows of a stream, the stream may be determined to be empty. When the stream holds a value of zero, the stream may be determined to be full. Other embodiments for determining a stream is full are possible and contemplated.

If the corresponding stream is determined to be full (conditional block 606), then the producer task may need to wait for the consumer task to move, or slide, to its next window in block 608. In one embodiment, the producer task may be placed in a “sleep” state or a wait state that is removed by the consumer task when the consumer task finishes and slides to a next window within the stream. A Boolean value may be used for this purpose, such as the full flag mentioned earlier. In another embodiment, a kernel scheduler may save the state of the producer task and place the task in a priority queue with a low priority to be returned to later, wherein the check for a full stream may be performed again. In yet another embodiment, the producer task may wait for a predetermined amount of time or number of clock cycles before performing the determination again. Communication with the operating system may be used for this implementation. In this embodiment, the producer task does not rely on the consumer task to inform the producer task of an available sliding window, and, therefore, to stop waiting. A subsequent update and comparison of the “write_buffer_index” value may be performed after the waiting time period. This polling action may continue until the comparison does not determine equal values, and, thus, the adjacent window is available. Other embodiments for determining a stream is full are possible and contemplated.

If a sliding window becomes available in a previously full stream or the stream was not initially full, the producer task may push one or more new values for corresponding array elements into the producer sliding window in block 610. In one embodiment, the index pointer “write_buffer_index” may already be set to point to the head of the current producer sliding window, but a previously set full flag Boolean value prevented any push operations from occurring. Once this Boolean value is reset, the push operations may proceed.

In the case of a necessary alignment, such as line 46 above, the specified number of elements are pushed, or written, into the producer sliding window. In one embodiment, the number of elements updated in a clock cycle may be one or the number may be more than one if the hardware supports a superscalar microarchitecture. A counter such as “write_index” may be decremented by the number of elements actually written, or pushed, in the corresponding clock cycle. Alternatively, the “write_index” value may be incremented if it is counting up the number of elements pushed, rather than counting down the number.

If an alignment is unnecessary, such as a flow data dependence is determined to be regular as one example is shown in FIG. 3A, then the first encountered push operation may be within a loop construct such as line 50 above. In one embodiment, the compiler may not have unrolled the loops in the producer and consumer tasks. For example, the producer task loop in lines 47-51 above may not have been unrolled. Therefore, the loops are serialized and the array elements may have their corresponding elements updated in the producer and consumer sliding windows in a sequential manner. In this embodiment, the number of elements updated in a clock cycle may be one or the number may be more than one if the hardware supports a superscalar microarchitecture. A counter such as “write_index” may be decremented by the number of elements actually written, or pushed, in the corresponding clock cycle. Once the “write_index” counter reaches zero, it may be determined the producer sliding window is full and it is time to move, or slide, to the next sliding window. Alternatively, the “write_index” counter may be incremented by the number of elements being pushed in a particular clock cycle and a full producer sliding window is determined when the “write_index” counter reaches a value equal to the total number of elements in a producer sliding window.

In another embodiment, the producer task loop in lines 47-51 above may have been unrolled by the compiler and the loop iterations may be executed out-of-order. In such an embodiment, a producer sliding window may have a pointer to both its head, such as the “write_buffer_index”, and a pointer to its tail. Multiple elements may be pushed out-of-order into the producer sliding window, but only when the elements have an address within the range of the producer sliding window. This out-of-bounds address issue more than likely would occur when the producer sliding window is nearly full. The counter “write_index” would be updated accordingly during each clock cycle.

Whether or not the elements are updated, or pushed, in block 610 in sequential order, out-of-order, one element per clock cycle, or multiple elements per clock cycle, a counter such as “write_index” needs to be updated upon the completion of the update. Alternatively, the “write_index” value may be a pointer to the next element to be updated in a producer sliding window in a sequential manner. When the “write_index” value matches a tail pointer value of the producer sliding window, then the producer sliding window may be considered full. After an update of the pointer or counter within the producer sliding window is performed, control flow of method 600 moves to conditional block 616.

After an initial, or first, push operation is encountered, whether or not alignment was necessary, a determination is made if the end of the sliding window is reached (conditional block 616). Although such a check may be unnecessary the majority of the time, since a producer sliding window more than likely may have more than one element, such a check is provided here to cover all cases. There are multiple manners to make this determination as discussed above regarding the value “write_index”. If the end of the producer sliding window is not reached (conditional block 616), then the end of the loop construct is determined whether or not to be reached (conditional block 618), such as the condition in line 47 above. If the end of the loop construct is not reached (conditional block 618), then control flow of method 600 moves to block 620 where an instruction within the loop construct is performed. For example, the loop instructions in lines 47-49 above are executed in block 620. If the next instruction is not a push operation in the code, then control flow will continue to loop back to block 620 until a push operation is encountered in the code (conditional block 612).

If a push operation is encountered (conditional block 612), the necessary number of elements are pushed into the sliding window in block 614 as described above regarding block 610. A processor core, such as core 112b, performing the producer tasks may need to fill multiple sliding windows before finishing computations for an array. Alternatively, the core may fill only one sliding window, or the core may fill less than one sliding window.

If the end of the producer sliding window is reached (conditional block 616), then it is time to slide the producer sliding window. However, if the stream is full (conditional block 606), then a wait may be required in block 608 as described earlier regarding block 608. Following, the index pointer may be updated to point to the head of the next sliding window. Alternatively, this pointer may have been updated already, but a Boolean value such as a full flag may have prevented further operation of the producer sliding window as described earlier. Once the stream is no longer full, the producer task may continue pushing elements into the producer sliding window and the appropriate counter or pointer may be updated in block 610.

If the end of a producer sliding window is not reached (conditional block 616), but the end of the loop construct is reached (conditional block 618), then an end-of-array flag may be set, such as in line 52 above, in block 622. This indication may include the storage of the address of the ultimate element of the stream. This indication may be used to communicate to a subsequent consumer task to complete its execution. This type of indication may be useful for a loop construct wherein the number of iterations is not known at compile time. Also, in one embodiment, the “write_buffer_index” pointer may be updated to point to the head of the next sliding window and the “write_index” value may be reinitialized for preparation of a subsequent producer task. Alternatively, these updates may occur at the opening of a new producer task.

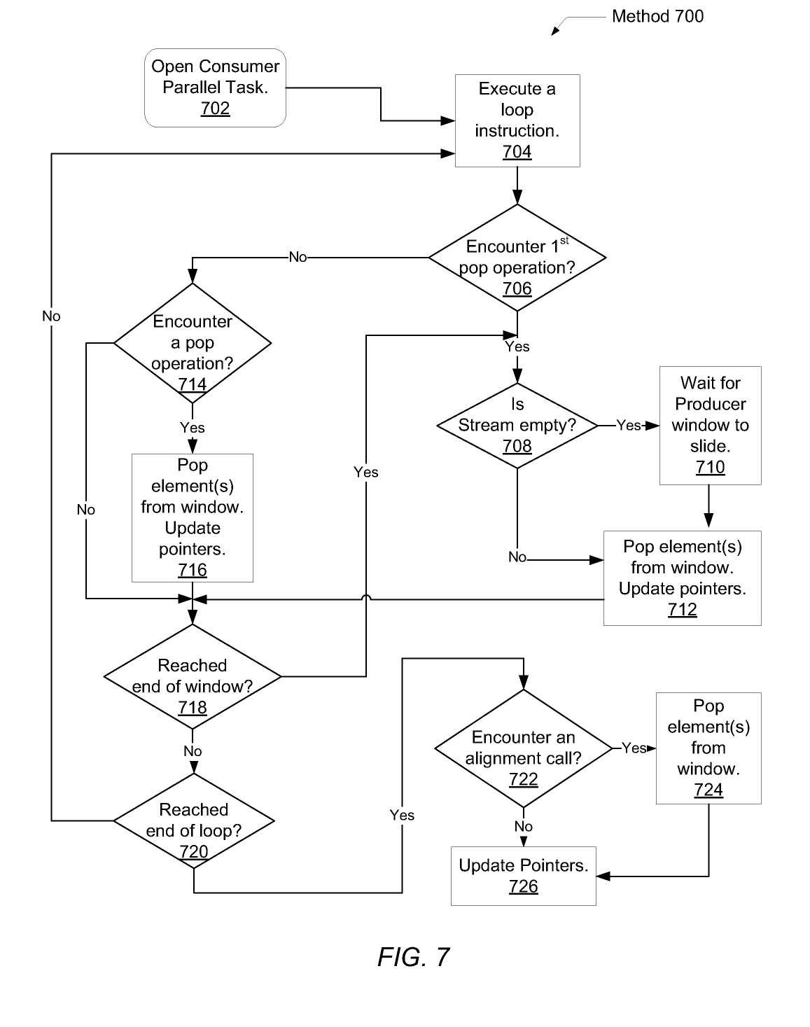

Turning now to FIG. 7, one embodiment of a method 700 for executing a consumer task is shown. Method 700 may be modified by those skilled in the art in order to derive alternative embodiments. The steps in this embodiment are shown in sequential order. However, some steps may occur in a different order than shown, some steps may be performed concurrently, some steps may be combined with other steps, and some steps may be absent in another embodiment. In the embodiment shown, a stream is created and index pointers are initialized, such as in line 40 in the above example, and a consumer task is opened in block 702, such as in lines 54-56 above. Of course, the pointer “read_buffer_index” and pointer/counter “read_index” may be used in a similar manner as the values “write_buffer_index” and “write_index” described above regarding method 600. Also, once one producer sliding window is filled with updated array elements by a corresponding producer task and the producer task pointers are updated to the next sliding window, the consumer task may execute concurrently with the producer task.

The execution of a consumer task is similar to the execution of a producer task except for two differences. First, a consumer task performs read, or pop, operations of elements within a sliding window. Second, alignment occurs at the end of the task, rather than at the beginning of the task as it occurs for a producer task.

Control flow of method 700 moves to block 704 where an instruction within the loop construct is performed. For example, the loop instructions in lines 57 and 60-61 above are executed one line at a time in block 704. If the next instruction is not a pop operation in the code, then control flow will continue to loop back to block 704 until a pop, or read, operation is encountered in the code.

Conditional block 706 to block 712 function in a similar manner as blocks 604-610 of method 600, except that elements are being read out of the consumer sliding window rather than being written into the consumer sliding window. An empty flag may be used in a similar manner as a full flag described above regarding method 600. Also, in one embodiment, two lines of code, such as lines 58-59 above, may be used to implement read and pointer update operations as described earlier.

Conditional block 714 to conditional block 720 function in a similar manner as blocks 612-618 of method 600, except again the elements are being read out of the consumer sliding window rather than being written into the consumer sliding window. Also, for conditional block 720, a determination for the end of loop may be the loop count itself in the code or it may be the end-of-stream flag set by the previous producer task.

Once the consumer task finishes work on a loop (conditional block 720), an alignment may be necessary as shown in line 62 above (conditional block 722). The flow dependence analysis may have determined a shifted data dependence, as one example is illustrated in FIG. 3B. Then a task alignment function call needs to be placed in the stream code, such as in line 62 above. In the case of a necessary alignment, the specified number of elements are popped, or read, from the consumer sliding window in block 724. In one embodiment, the number of elements read in a clock cycle may be one or the number may be more than one if the hardware supports a superscalar microarchitecture. A counter such as “read_index” may be decremented by the number of elements actually read, or pushed, in the corresponding clock cycle. Alternatively, the “read_index” value may be incremented if it is counting up the number of elements pushed, rather than counting down the number.

In one embodiment, in block 726, the “read_buffer_index” pointer may be updated to point to the head of the next sliding window and the “read_index” value may be reinitialized for preparation of a subsequent consumer task. Alternatively, these updates may occur at the opening of a new consumer task.

Although the embodiments above have been described in considerable detail, numerous variations and modifications will become apparent to those skilled in the art once the above disclosure is fully appreciated. It is intended that the following claims be interpreted to embrace all such variations and modifications

What is claimed is:

1. A method for managing memory accesses, the method comprising:
allocating a stream in memory, the stream comprising a first plurality of elements;
dividing the stream into a plurality of windows, each window including a plurality of elements less than the first plurality of elements;
designating a first window of said windows as a producer sliding window, the producer sliding window being exclusively accessible by a producer;
performing one or more write operations into one or more elements of the producer sliding window; and
sliding the producer sliding window from the first window to a second window of the windows in response to determining:
the producer has written to all elements of the first window; and
the second window does not contain any data produced by the producer which has not been consumed.

2. The method as recited in claim 1, further comprising a consumer consuming data produced by the producer.

3. The method as recited in claim 2, further comprising designating a window of said windows as a consumer sliding window which is exclusively accessible by the consumer.

4. The method as recited in claim 3, wherein the producer may write to a producer sliding window concurrent with the consumer consuming from a consumer sliding window.

5. The method as recited in claim 4, wherein said stream comprises a circular queue, and said plurality of windows are non-overlapping.

6. The method as recited in claim 5, further comprising sliding the producer sliding window from a third window to a fourth window of the windows in response to determining:
the consumer has consumed all elements of the third window; and
the fourth window is not currently designated a producer sliding window.

7. The method as recited in claim 6, further comprising a producer pointer corresponding to the producer sliding window, and a consumer pointer corresponding to the consumer sliding window, the method further comprising determining said stream is empty, wherein determining the stream is empty comprises determining the consumer pointer equals the producer pointer.

8. The method as recited in claim 3, wherein in response to detecting an irregular data flow dependence of application code, the method further comprises:
performing one or more alignment write operations into one or more elements of the producer sliding window; and
performing one or more alignment read operations from one or more elements of the consumer sliding window.

9. A computer readable storage medium storing program instructions operable to minimize synchronization support for generated concurrent producer and consumer tasks, wherein the program instructions are executable to:
allocate a stream in memory, the stream comprising a first plurality of elements;
divide the stream into a plurality of windows, each window including a plurality of elements less than the first plurality of elements;
designate a first window of said windows as a producer sliding window, the producer sliding window being exclusively accessible by a producer;
perform one or more write operations into one or more elements of the producer sliding window; and
slide the producer sliding window from the first window to a second window of the windows in response to determining:
the producer has written to all elements of the first window; and
the second window does not contain any data produced by the producer which has not been consumed.

10. The storage medium as recited in claim 9, further comprising a consumer consuming data produced by the producer.

11. The storage medium as recited in claim 9, wherein the program instructions are further executable to designate a window of said windows as a consumer sliding window which is exclusively accessible by the consumer.

12. The storage medium as recited in claim 11, wherein the producer may write to a producer sliding window concurrent with the consumer consuming from a consumer sliding window.

13. The storage medium as recited in claim 12, wherein said stream comprises a circular queue, and said plurality of windows are non-overlapping.

14. The storage medium as recited in claim 13, wherein the program instructions are further executable to slide the producer sliding window from a third window to a fourth window of the windows in response to determining:
the consumer has consumed all elements of the third window; and
the fourth window is not currently designated a producer sliding window.

15. The storage medium as recited in claim 14, further comprising a producer pointer corresponding to the producer sliding window, and a consumer pointer corresponding to the consumer sliding window, wherein the program instructions are further executable to determine said stream is empty, wherein determining the stream is empty comprises determining the consumer pointer equals the producer pointer.

16. The storage medium as recited in claim 11, wherein in response to detecting an irregular data flow dependence of application code, the program instructions are further executable to:
perform one or more alignment write operations into one or more elements of the producer sliding window; and
perform one or more alignment read operations from one or more elements of the consumer sliding window.

17. A computing system comprising:
one or more processors comprising one or more processor cores;
a compiler configured to:
allocate a stream in memory, the stream comprising a first plurality of elements;
divide the stream into a plurality of windows, each window including a plurality of elements less than the first plurality of elements;
designate a first window of said windows as a producer sliding window, the producer sliding window being exclusively accessible by a producer;
perform one or more write operations into one or more elements of the producer sliding window; and
slide the producer sliding window from the first window to a second window of the windows in response to determining:
the producer has written to all elements of the first window; and
the second window does not contain any data produced by the producer which has not been consumed.

18. The computing system as recited in claim 17, wherein the compiler is further configured to designate a window of said windows as a consumer sliding window which is exclusively accessible by the consumer.

19. The computing system as recited in claim 18, wherein the producer may write to a producer sliding window concurrent with the consumer consuming from a consumer sliding window.

20. The computing system as recited in claim 19, wherein the program instructions are further executable to slide the producer sliding window from a third window to a fourth window of the windows in response to determining:
the consumer has consumed all elements of the third window; and
the fourth window is not currently designated a producer sliding window.
